(19) United States
(12) Patent Application Publication
(10) Pub. No.: US 2015/0242924 A1
(43) Pub. Date: Aug. 27, 2015

(54) SYSTEMS AND METHODS FOR USING CUSTOMER INFORMATION TO ENABLE CUSTOMER INTERACTION

(71) Applicant: Verizon Patent and Licensing Inc., Arlington, VA (US)

(72) Inventors: Jonathan Lott, Wylie, TX (US); Omar A. Abou-Shamis, Irving, TX (US); Christi M. Lott, Garland, TX (US); Kenneth W. Wiley, Fort Worth, TX (US)

(73) Assignee: Verizon Patent and Licensing Inc., Arlington, VA (US)

(21) Appl. No.: 14/191,022

(22) Filed: Feb. 26, 2014

(51) Int. Cl. G06Q 30/06; G06Q 30/02

(52) U.S. Cl. CPC G06Q 30/0623; G06Q 30/0267

(57) ABSTRACT

Techniques are described herein to connect customers of a company with one another. In one implementation, a method may include receiving a search query for businesses that are local to a user; determining, based on access of a data structure, a location of a residence of the user; and generating, based on the location of the residence of the user and the search query, search results that satisfy the search query. The search results may include information relating to at least one business that is a local businesses relative to the location of the residence of the user. For example, the information may include: identification of a name of the at least one business, identification of an address of the at least one business, and information relating to one or more telecommunication services that are offered by the at least one business.

### BACKGROUND

A company or other entity may provide services to customers of the company. For example, a telecommunications provider may provide services relating to television delivery, wired network connectivity (e.g., Internet access), cellular wireless mobile data and voice services, and/or wired phone services.

In the course of the providing of the services, the telecommunications provider may obtain information relating to the customers, such as demographic information, service usage information, or other information.

### BRIEF DESCRIPTION OF THE DRAWINGS

FIG. 1 is a diagram illustrating an overview of concepts described herein;

FIG. 2 is a diagram illustrating an example environment in which systems and/or methods described herein may be implemented;

FIG. 3 is a diagram illustrating an example implementation of the environment shown in FIG. 2;

FIGS. 4A and 4B are diagrams illustrating example data structures;

FIG. 5 is a diagram illustrating an example of a graphical interface that may be provided by the server shown in FIG. 2;

FIG. 6 is a flow chart illustrating an example process relating to the processing of search queries to find or locate businesses;

FIG. 7 is a diagram illustrating an example of a user interface that may be provided to a user as part of the providing of search results to the user;

FIG. 8 is a flow chart illustrating example process to the providing of messages, such as broadcast messages, to users.

FIGS. 9A and 9B are diagrams illustrating an example of graphical interfaces that may be provided as part of broadcasting messages;

FIG. 10 is a flow chart illustrating an example process relating to the providing of social network posts, associated with businesses, to users; and

FIG. 11 is a diagram of example components of a device.

### DETAILED DESCRIPTION OF PREFERRED EMBODIMENTS

The following detailed description refers to the accompanying drawings. The same reference numbers in different drawings may identify the same or similar elements.

Techniques are described herein to connect customers of a company, such as a telecommunications company, with one another. The customers may include commercial customers (referred to herein as “businesses”) and residential customers (referred to herein as “users”). The connecting of the customers may refer to enabling customers to easily find one another, communicate with one another, and/or to determine services offered (e.g., the services offered by a business to users). As an example, a user may search for businesses that are near the user or in a neighborhood of the user and that are currently providing certain services that are desired by the user. The certain services may include, for example, providing food and drink (e.g., a bar or restaurant) and showing a particular sporting event (e.g., a football game).

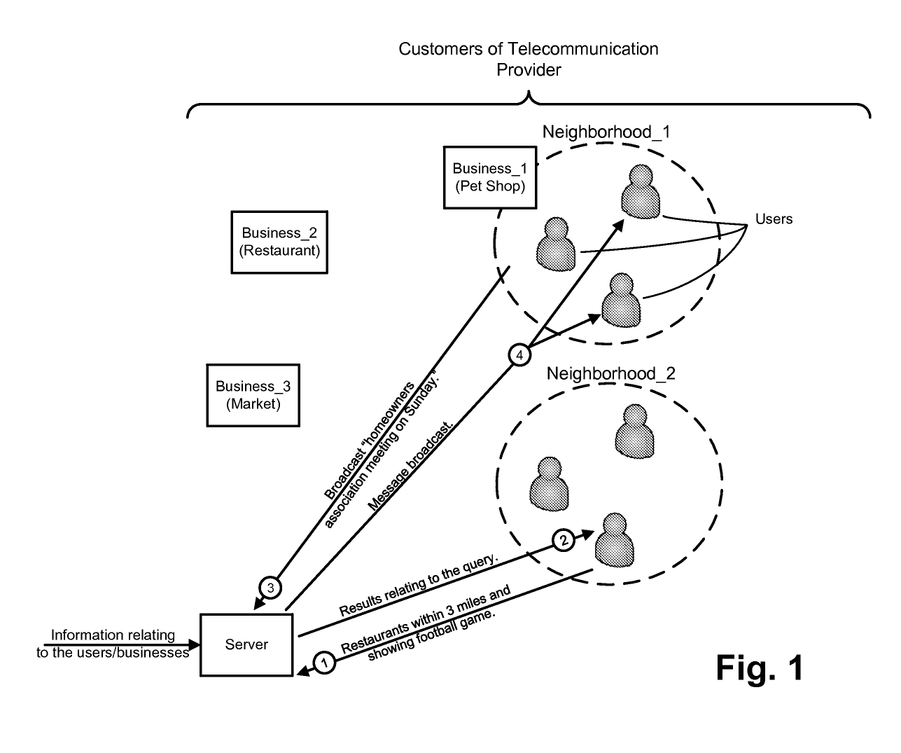

FIG. 1 is a diagram illustrating an overview of concepts described herein. As illustrated, customers of a telecommunication provider may include a number of businesses, illustrated as business_1 (a pet shop), business_2 (a restaurant), and business_3 (a market), and a number of residential customers (users). The users may be located in neighborhoods. For instance, a first neighborhood (neighborhood_1) may include a number of users (e.g., associated with home residences) that subscribe to services of the telecommunication provider. A second neighborhood (neighborhood_2) may include a second number of users that also subscribe to services of the telecommunication provider. The businesses illustrated in FIG. 1 may include businesses that are local, relative to the users (e.g., within driving distances a typical user would be willing to drive to go to the business or within a particular distance of the user).

Consistent with aspects described herein, a server, such as a server controlled by the telecommunication provider, may store information relating to the users and/or the business. For example, the information may include user/business identity information, location information (e.g., a geographical address or a particular neighborhood to which the user/business belongs), and/or social networking information (such as social networks used by the particular business). The information may also include information relating to the usage of particular services offered by the telecommunication provider. For example, a restaurant, that subscribes to television services offered by the telecommunication provider, may display sporting events on televisions in the restaurant. In this situation, the information may include television channels that are being viewed at the restaurant. As another example, a business may offer Wi-Fi hotspots (i.e., local area network services) to its customers, where the network connection for the Wi-Fi service is obtained from the telecommunication provider. In this situation, the information may include an indication of which businesses offer Wi-Fi hotspots and potentially other information, such as the speed of the Wi-Fi hotspots, passwords associated with the Wi-Fi hotspots, or other information relating to the usability of the Wi-Fi hotspots.

The server may provide a number of services relating to searching, discovery, and/or connecting of the users and/or businesses with one another. For example, a user wishing to visit a local restaurant may submit a query to the server (arrow “1”). The query may be a query for local restaurants that are showing, on a television, a particular sporting event. For example, the user may search for restaurants within 3 miles of the user's location and that are showing a particular football game. As another example, the query may be a request for the current sporting events being shown by a particular restaurant. The user may generate the query using, for example, an application (“app”) installed at a mobile device (e.g., a smart phone or tablet) associated with the user or via a set-top box (STB) associated with the user's residence. The server may respond to the query and return relevant information to the user (arrow “2”), such as an identification of business_2 as being a restaurant that is near the user and is currently showing the sporting event that is desired by the user.

In some implementations, the server may enable the providing of messages or notifications between users and/or businesses in a particular geographical area. For example, as part of providing telecommunication services to a neighborhood, the telecommunication provider may be aware of the residences within particular neighborhoods. A user within a neighborhood may use the server to broadcast a message to other users within the neighborhood. For example, a user within neighborhood_1 may request that the message “homeowners associating meeting on Sunday” be broadcast to other users within neighborhood_1 (arrow “3”). The server may then transmit the message to users that are associated with neighborhood_1 and that have chosen to receive such messages (arrow “4”). The messages may be provided, for example, via a graphical interface provided by a STB (e.g., on a television of a user) or through an interface associated with a mobile device, such as a smart phone or tablet.

In some implementations, businesses may permit the server to retrieve information from social network feeds in which the business participates. Updates to the social network feeds by the business may then be provided to select users, such as users that choose to receive the social network feeds of particular businesses, users that are near the businesses, and/or users that have previously frequented the businesses.

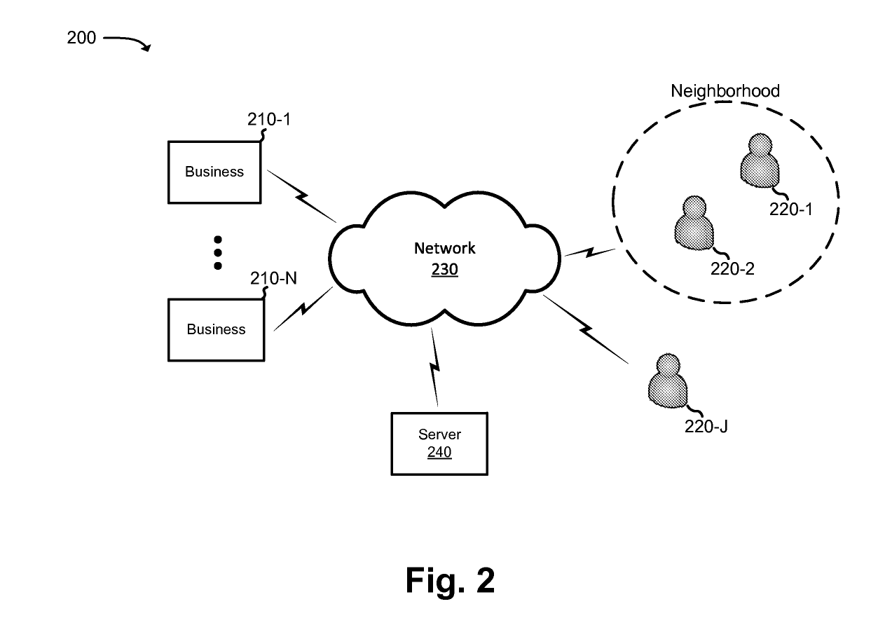

FIG. 2 illustrates an example environment 200 in which systems and/or methods described herein may be implemented. As shown in FIG. 2, environment 200 may include one or more businesses 210-1 through 210-N (where N is an integer greater than or equal to 1), users 220-1 through 220-J (where J is an integer greater than or equal to 2), network 230, and server 240. Environment 200 may correspond to an environment in which a telecommunications provider provides services to customers, via network 230, to a number of business customers (businesses 210) and residential customers (users 220).

Businesses 210 may include businesses that receive telecommunication services, via network 230, from a telecommunication provider. The telecommunication provider may act as, for example, a provider of television services, a provider of wireless phone services (e.g., cellular wireless services), a provider of wired phone and/or networking services (e.g., network connectivity provided via fiber optic cable or coaxial cable connections), and/or a provider of other services.

Users 220 may represent or be associated with residences that include devices that receive telecommunication services, via network 230, from the telecommunication provider. Users 220 may include users within neighborhoods (e.g., users 220-1 and 220-2) and/or users that are not associated with a particular neighborhood (user 220-J). The telecommunication provider, as part of the installation of telecommunication services to users 220 and/or businesses 210, may maintain information associating users 220 and/or businesses 210 with particular neighborhoods. For example, as illustrated, users 220-1 and 220-2 may be associated with a neighborhood, and user 220-J may not be associated with a neighborhood. That is, in this example, user 220-J may not be associated with any neighborhood at all.

Network 230 may include wired and/or wireless networks that are managed by the telecommunication provider. For example, network 230 may include, for example, a local area network (LAN), a wide area network (WAN), a metropolitan area network (MAN), and/or another type of network. In some implementations, network 230 may include a packet-based Internet Protocol (IP) network, and connectivity to network 230 may be achieved through wireless connections (e.g., a cellular wireless network). Alternatively or additionally, network 230 may represent a network that provides wired services to customers, such as phone and/or data connectivity that is provided through fiber optic and/or coaxial cables installed to the premises of users 220.

Server 240 may include one or more computing devices to receive and/or maintain information relating to businesses 210 and users 220, and to, based on the information, provide search results, messages, and/or social status updates to businesses 210 and users 220. Although referred to as a “server” herein, server 240 may include a single computing device, clusters of computing devices (e.g., blades or rack-mounted server computers) that are co-located or geographically distributed, cloud-based (e.g., computing as a service) computing solutions, or other arrangements of computing devices. The operation of server 240 with respect to businesses 210 and users 220, in accordance with some implementations, will be described in more detail below.

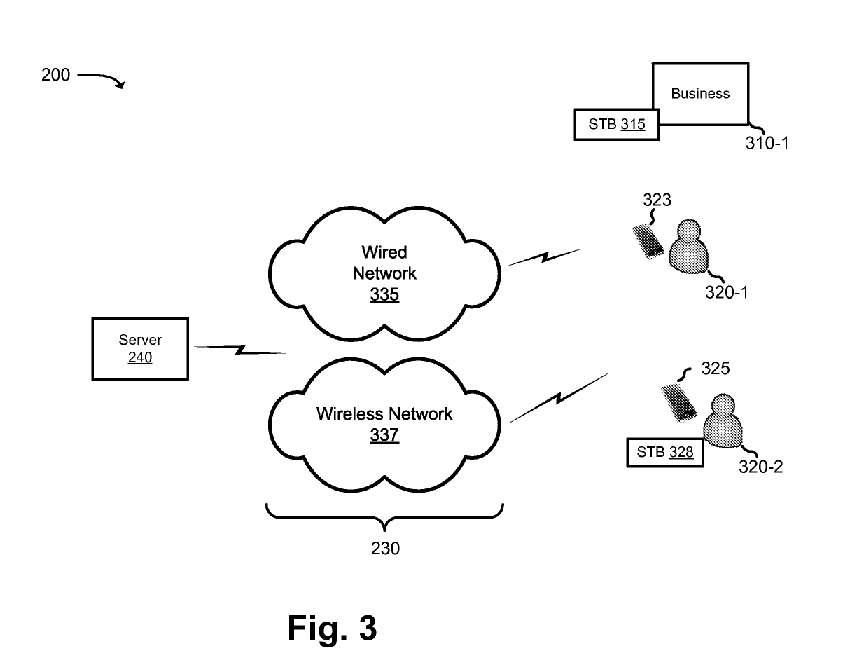

FIG. 3 is a diagram illustrating an example implementation of environment 200. As illustrated in FIG. 3, environment 200 may include business 310-1, and users 320-1 and 320-2. Network 230, as illustrated, may include wired network 335 and wireless network 337 (e.g., a cellular wireless network).

Business 310-1 may include a business that receives, via network 230, services such as cable television, telephone services, and network (e.g., Internet) connectivity. The services may be provided via a wired connection to network 230, such as a fiber optic cable connection or coaxial cable connection. Business 310-1 may include one or more devices to facilitate the receiving of network services via wired network 335, such as STB 315, which may be used to output television signals to televisions associated with business 310-1. User 320-1 may be associated with a residence that receives, via wireless network 337, services such as wireless phone service (e.g., user 310-1 may have a smartphone 325). User 320-2 may be associated with a residence that receives, via wireless network 337, services such as wireless phone and data service, and via wired network 335, wired phone service and cable television. For example, as illustrated, user 320-1 may be associated with smartphone 323, which connects to wireless network 337, and user 320-2 may be associated with smartphone 325, which connects to wireless network 337 and STB 328, which connects to wired network 335.

Wired network 335 may include a network used to deliver telecommunication services to residences, businesses, or other entities, in which the “last mile” connection from the network to the residence or business includes a wired connection, such as a fiber optic or coaxial-based connection. Wired network 335 may be used to provide, for example, television services, network connectivity (e.g., an Internet connection), traditional telephone services, and/or other services.

Wireless network 337 may include a network providing telecommunication services to residences, businesses, or other entities in which the connection with a user's mobile device (e.g., smart phone, personal digital assistant, tablet, or other communication device) is implemented via a wireless connection. Wireless network 337 may include networks based on the Long Term Evolution (LTE) standards or other standards.

Although FIGS. 2 and 3 illustrate example components of environment 200, in other implementations, environment 200 may contain fewer components, different components, differently arranged components, or additional components than those depicted. Alternatively, or additionally, one or more components of environment 200 may perform one or more other tasks described as being performed by one or more other components of environment 200.

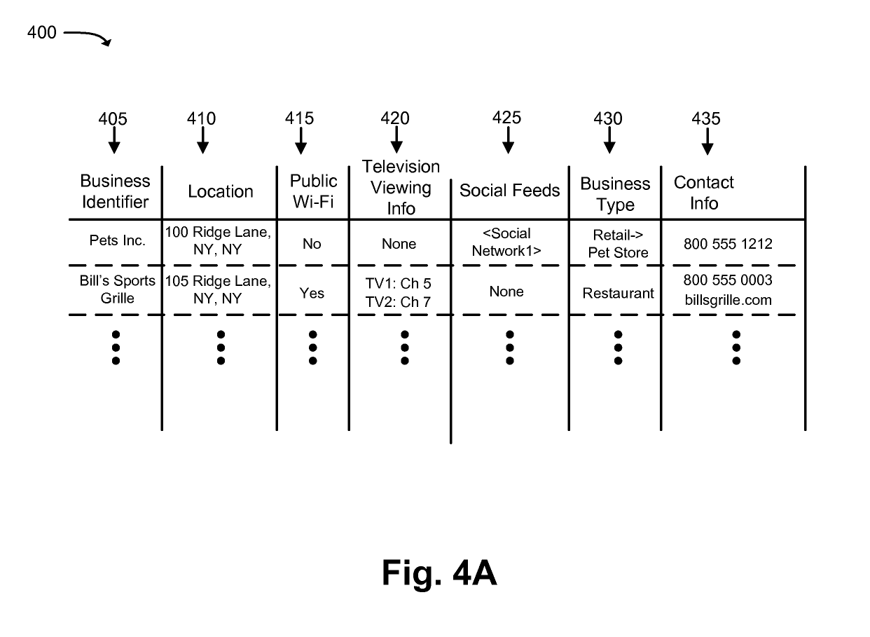

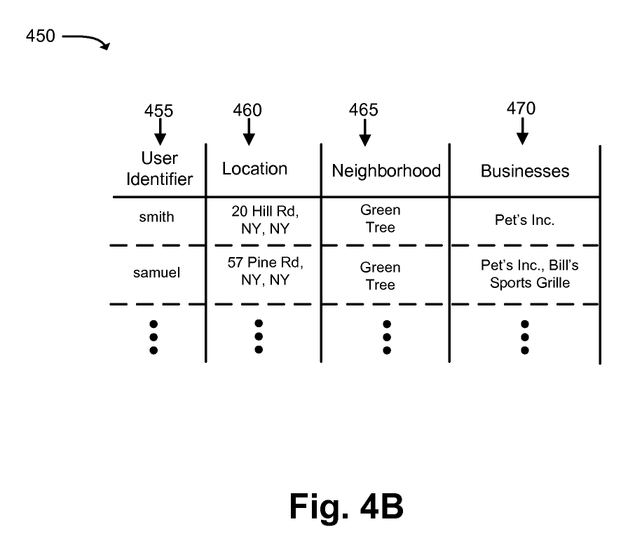

FIGS. 4A and 4B are diagrams illustrating example data structures 400 (FIG. 4A) and 450 (FIG. 4B), such as a data structure that may be maintained by server 240. The data structures of FIGS. 4A and 4B may generally be used to store information relating to businesses 210 and users 220.

As illustrated, data structure 400 may include a number of fields, including: business identifier field 405, location field 410, public Wi-Fi field 415, television viewing information (info) field 420, social feeds field 425, business type field 430, and contact information (info) field 435. Each record in data structure 400, corresponding to one set of fields 405-435, may represent information associated with a particular business 210. The fields shown for data structure 400 are examples. In alternative possible implementations, different, fewer, or additional fields may be implemented.

Business identifier field 405 may include information identifying particular businesses, such as a business name, an account name or login value that is used by the telecommunication provider to identify the business, and/or some other value or values. Location field 410 may include information identifying the location (e.g., a geographic location and/or a geographic region) of the business. The information identifying the location of the business may include, for example, latitude/longitude values, an address, or other values. In some situations, location field 410 may additionally include information identifying one or more neighborhoods to which the business belongs and/or primarily serves.

Public Wi-Fi field 415 may indicate whether the business provides public Wi-Fi access to its customers. In some implementations, in addition to indicating whether a business provides public Wi-Fi access to its customers, field 415 may include other information, such as the speed of the Wi-Fi hotspots, passwords associated with the Wi-Fi hotspots, or other information relating to the usability of the Wi-Fi hotspots.

Television viewing information field 420 may indicate whether the business provides television show(s) for customers. For example, a restaurant, a sports bar, or other businesses may obtained television services through the telecommunication provider, which may be displayed to customers of the business. In some implementations, television viewing information field 420 may indicate television programs that are currently being displayed by the business. For example, STB 315, at business 310-1, may transmit messages to server 240 to indicate the current television channel that is being watched at business 310-1. Alternatively or additionally, in some implementations, television viewing information field 420 may include information indicating television programs that are scheduled to be shown at the business (e.g., upcoming pay-per-view shows that have been ordered).

Social feeds field 425 may include information indicating whether the business participates in social networks and may additionally include information identifying the social network feeds. In this manner, content posted to the social network feeds by the business may be obtained by server 240 and provided to interested users 220 and/or subscribers that elect to be provided with the social network feeds.

Business type field 430 may include information indicating the type, category, or affiliation associated with the business. For example, possible categories may include “restaurant,” “bar,” “food market,” “pet store,” etc. Contact information field 435 may include contact information for the business, such as one or more telephone numbers, an address, an email address, a website address, business operating hours, etc.

Information associated with business identifier field 405, location field 410, public Wi-Fi field 415, television viewing information field 420, social feeds field 425, business type field 430, and/or contact information field 435 may be obtained during initial provisioning and/or registration of the business with the communication provider. Alternatively or additionally, the information associated with some or all of these fields may be obtained at other times, such as based on the business providing the information via an electronic form (e.g., a web form) or paper form.

Two example records are particularly illustrated in FIG. 4A. As shown, the first record corresponds to the business “Pets Inc.” (field 405). This business is located at “100 Ridge Lane, N.Y., NY,” (field 410), does not provide public Wi-Fi access (field 415), and does not provide a public television for viewing (field 420). This business may additionally participate in a social network “Social Network 1” (field 425). Field 425 may include identification or other information that server 240 can use to provide social network entries or posts, by the business, to users 220. The business is associated with the category “retail->pet store” (field 430) and may be reached at the contact telephone number “800 555 1212” (field 435). Similarly, the second business in data structure 400 may include the business “Bill's Sports Grille” (field 405), which is located at “105 Ridge Lane, N.Y., NY” (field 410), provides public Wi-Fi access (field 415), and provides two televisions for viewing by its customers. The televisions may currently be displaying channels 5 and 7, respectively (field 420). This business may be associated with the category “restaurant” (field 430) and may be reached at the contact telephone number “800 555 0003” and/or the web site “billsgrille.com” (field 435).

As illustrated in FIG. 4B, data structure 450 may include a number of fields, including: user identifier field 455, location field 460, neighborhood field 465, and business field 470. Each record in data structure 450, corresponding to one set of fields 455-470, may represent information associated with a user 220. The fields shown for data structure 450 are examples. In alternative possible implementations, different, fewer, or additional fields may be implemented.

User identifier field 455 may include information identifying a particular user, such as the user's name, an account name or login value that is used by the telecommunication provider to identify the user, or some other value or values. Location field 460 may include information identifying the location of the user's residence. The information identifying the location of the user's residence may include, for example, latitude/longitude values, an address on a map, or other values.

Neighborhood field 465 may include information identifying a neighborhood associated with the user's residence. The neighborhood may be identified by, for example, a neighborhood name or some other value. Business field 470 may include information indicating one or more businesses in which the user has expressed an interest. For example, business field 470 may include a list of businesses (e.g., that are in data structure 400) that the user has explicitly chosen to follow or be provided with information relating to the businesses. Alternatively or additionally, business field 470 may include other information that indicates preferences the user may have with respect to information, regarding businesses, that are provided to the user (e.g., one or more business categories in which the user has indicated an interest).

As with data structure 400, information associated with the fields of data structure 450 may be obtained during initial provisioning and/or registration of the user with the communication provider. Alternatively or additionally, the information associated with these fields may be obtained at other times, such as based on the user providing the information via electronic form (e.g., a web form) or a paper form.

Two example records are particularly illustrated in FIG. 4B. As shown, the first record of data structure 450 corresponds to the user that has the account login name “smith” (field 455). The user's residence may be located at “20 Hill Rd, N.Y., NY” (field 460), which may be in the neighborhood “Green Tree” (field 465). The user may have previously indicated an interest in the business “Pet's Inc.” (field 470). Similarly, the second record of data structure 450 may correspond to the user that has the account login name “samuel” (field 455). The user's residence may be located at “57 Pine Rd, N.Y., NY” (field 460), which may be in the neighborhood “Green Tree” (field 465). The user may have previously indicated an interest in the business “Pet's Inc.” and “Bill's Sports Grille” (field 470).

Some or all of the information included in data structures 400 and 450 may be information obtained from during the normal course of business of the telecommunications provider. Alternatively or additionally, other techniques could be used to obtain the information in data structures 400 and 450, such as be requesting the user fill out a form.

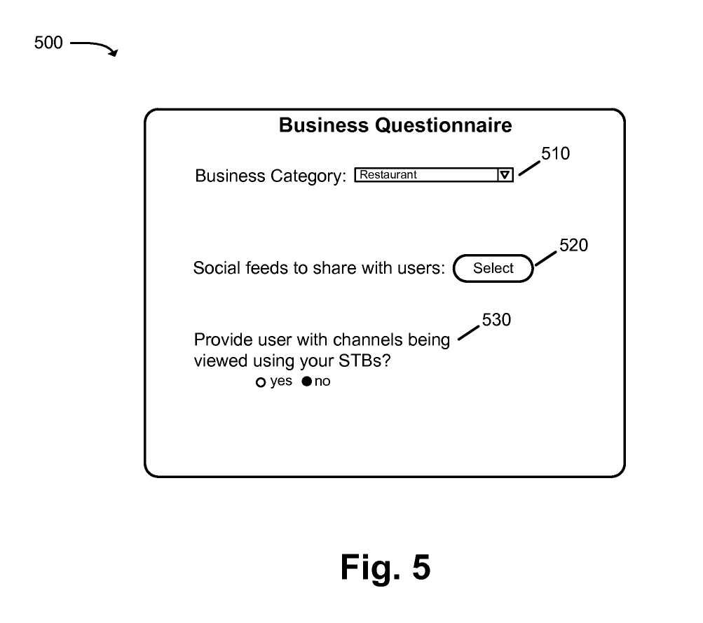

FIG. 5 is a diagram illustrating an example of a graphical interface 500 that may be provided by server 240. Graphical interface 500 may be an interface that may be provided by server 240 to businesses 210, to obtain information relating to businesses 210. For example, interface 500 may be provided to determine information that business 210 would like to provide to users 220. In one implementation, interface 500 may be a graphical interface provided via a web form.

In the example shown in FIG. 5, interface 500 may include a menu to obtain the business category or type associated with a business. For example, drop-down menu 510 may allow a business owner to select an appropriate business category (e.g., “restaurant”). Selection button 520 may allow the business owner to enter information relating to a social network or social feeds that the business participates in and that the business would like to share with users 220. Radio buttons 530 may allow the business owner to indicate whether television channels that are currently being viewed by the business should be shared with users.

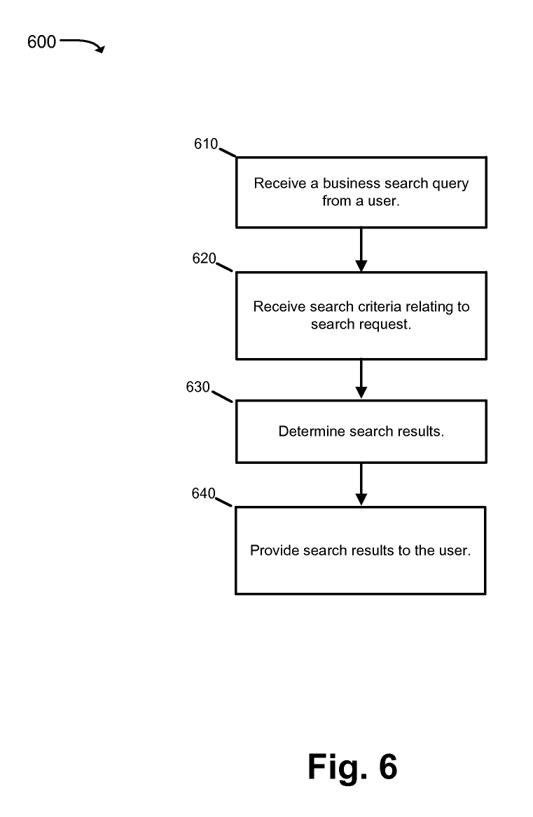

FIG. 6 is a flow chart illustrating an example process 600 relating to the processing of search requests to find or locate businesses. Process 600 may be performed by, for example, server 240.

Process 600 may include receiving a business search query from a user (block 610). The business search query may be a request, from a user 220, to find a particular business or to find information relating to a particular business. The query may be entered through a web-based form (e.g., with server 220 acting as a web server), from an interface presented by a set-top box (e.g., via STB 328 in which the user provided information to STB 328 using the user's television as an interface), and/or via an application executing at a smartphone (e.g., smartphone 323/325 may include an application provided by a telecommunication provider).

Process 600 may further include receiving search criteria relating to the search request (block 620). In one implementation, the search criteria may be entered as part of the search request. The search criteria may include information such a distance (e.g., find businesses with a particular distance of the user's residence or within a particular distance of the user's current location (as determined by the user's smartphone)), a business type, services offered by the business (e.g., find businesses offering Wi-Fi, find businesses showing a particular television channel or pay per view program, etc.), or other search criteria.

Process 600 may further include determining, based on the search criteria, search results (block 630). In one implementation, server 240 may determine the search results based on matching of the search criteria to one or more of data structures 400 and 450. For example, for a search query that includes a request to find businesses in a certain distance of the user's residence, server 240 may user the location of the user's residence (field 460 of data structure 450) and the location of businesses (field 410 of data structure 400) to determine the businesses that are within the certain distance of the user's residence. As another example, for a search query that includes a request to find a business that is within the user's neighborhood or within a certain distance of the user's neighborhood, server 240 may determine the user's neighborhood from field 465 of data structure 450 (and also a location or area corresponding to the neighborhood) and the location of businesses determine the relevant businesses. As another example, the search query may include a request to find businesses that are within a certain distance the user's residence and that provide certain features, such as Wi-Fi or that are showing particular television channels. For these searches, server 240 may additionally determine search results based on information from data structure 400.

Process 600 may further include providing the search results to the user (block 640). For example, the search results may be provided over network 230 to a mobile device, STB, or other device that is associated with user 220.

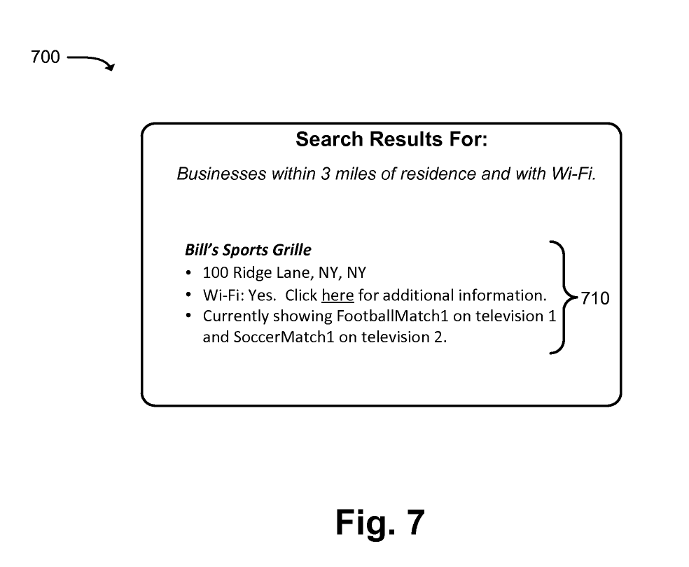

FIG. 7 is a diagram illustrating an example of a user interface 700 that may be provided to a user as part of the providing of search results to the user (e.g., as performed in block 640). User interface 700 may be a graphical user interface that may be provided by server 240 to a computing device of user 220. User interface 700 may be, for example, a graphical interface provided via a web interface, displayed on a television associated with a set-top box, or an interface provided by an application executing on a smartphone.

In the example shown in FIG. 7, user interface 700 may be provided to display search results, associated with a particular user, for the example search for “businesses with 3 miles of residence and with Wi-Fi.” In this example, assume a single search result 710 is returned to user 220. The search result corresponds to the business “Bill's Sports Grill.” In addition to the name of the business, search result 710 may include the address of the business and information indicating that Wi-Fi is available at the business. In this example, the information indicating that Wi-Fi is available may include a link, which may, for example, provide additional information relating to the Wi-Fi, such as a password associated with the Wi-Fi hotspots, or other information relating to the usability of the Wi-Fi. As is further illustrated in FIG. 7, search result 710 may include other information relating to the business, such as an indication of the television programs that are currently being shown by the business. Alternatively or additionally, the indication of the television programs that are currently being shown by the business may include an indication of television programs that are scheduled to be shown by the business (such as an upcoming pay-per-view program that has been ordered by the business). As mentioned previously, at least some of the information provided through user interface 700 (e.g., information relating to the Wi-Fi hotspots or the indication of television programs that are currently being shown) may be information that is obtained by a telecommunication provider as part of the normal operation of the telecommunication provider.

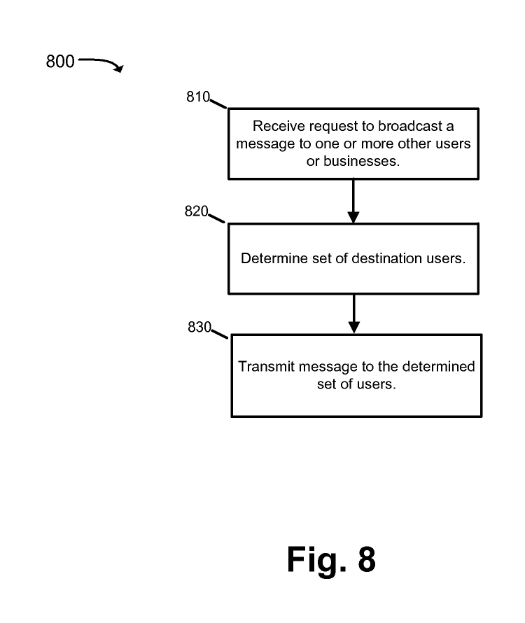

FIG. 8 is a flow chart illustrating example process 800 relating to the providing of messages, such as broadcast messages, to users. Process 800 may be performed by, for example, server 240.

Process 800 may include receiving a request to broadcast a message to one or more other users or businesses (block 810). For example, user 220-1 may decide to broadcast a message to other users 220, such as other users that are in the neighborhood of user 220-1. User 220-1 may enter the message via an interface provided by, for example, a set-top box at the user's residence, an application installed on smartphone or other mobile device, and/or via a web interface. The set-top box and/or application may transmit a request to broadcast the message to server 240.

Based on the request to broadcast the message, a set of destination users (and/or businesses) may be determined (block 820). In one implementation, server 240 may receive the request to broadcast the message and may determine the set of destination users based on data structures 400 and 450. For example, for a request to broadcast the message to other users in the neighborhood of the requesting user, server 240 may use data structure 450 to determine the neighborhood of the requesting user and the other users in the neighborhood. In some implementations, users may opt-in or opt-out to receiving messages. For example, a user may choose to never be provided with messages from other users or to never be provided with messages from a particular other user. As another example, a request to broadcast a message from user 220-1 may include a request to broadcast a message to other users and/or businesses that are within a particular geographic distance (e.g., 10 miles) of the residence of user 220-1. In this example, server 240 may then determine the appropriate set of destination users. As yet another example, business 210-1 may submit a request to broadcast a message to users 220 that are within particular neighborhood(s), are within a certain distance of the business, and/or to users that have previously indicated an interest in receiving messages from business 210-1.

Process 800 may further include transmitting the message to the determined set of users (block 830). In one implementation, server 240 may transmit a copy of the message to each user and/or business that is in the determined set of destination users. The message may be presented to the destination users as a pop-up message, as an email message, or as a message in another format.

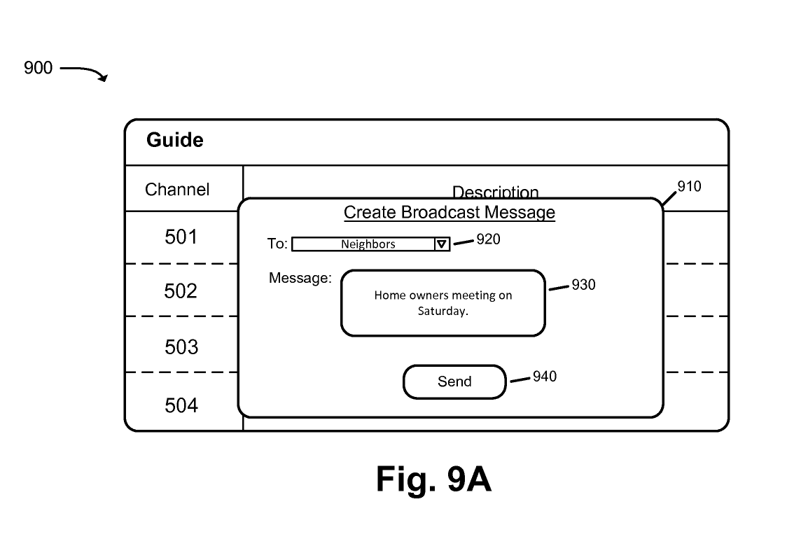

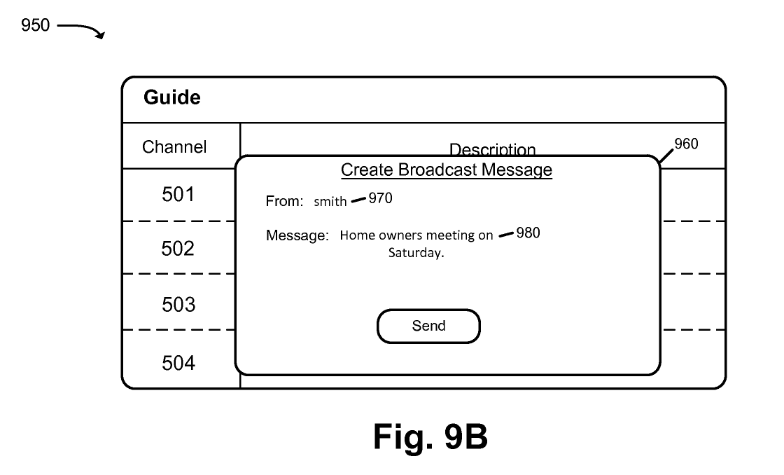

FIGS. 9A and 9B are diagrams illustrating an example of graphical interfaces 900 and 950 that may be provided as part of broadcasting messages. In the examples of FIGS. 9A and 9B, a broadcast message is illustrated as being initiated by and received by a user associated with a television and a set-top box. In other possible implementations, other devices (e.g., a smartphone, tablet, computer, or other device) may be used to initiate and receive broadcast messages.

As shown in FIG. 9A, interface 900 may include a graphical interface provided by a set-top box, such as STB 328. User 220-2 may have indicated a desire to send a broadcast message through the interface provided by STB 328. As illustrated, in this example, STB 328 may display a pop-up window 910 that includes a number of options for the broadcast message. For instance, the user may enter one or more participants in “to” field 920. In this example, the user has selected to send the broadcast message to the group “neighbors,” which may represent other users in the same neighborhood as the user. The substantive text for the broadcast message may be entered into box 930 (“Home owners meeting on Saturday”). The user may select send button 940 when the user is ready to initiate the transfer of the broadcast message to server 240.

FIG. 9B illustrates an example interface 950 for presenting the broadcast message, from FIG. 9A, to another user. In this example, pop-up window 960 may be provided to the receiving user to indicate that a message has been received. Pop-up window 960 may include a text field 970 that indicates the sender of the message (“smith”) and a text field 980 that includes the message.

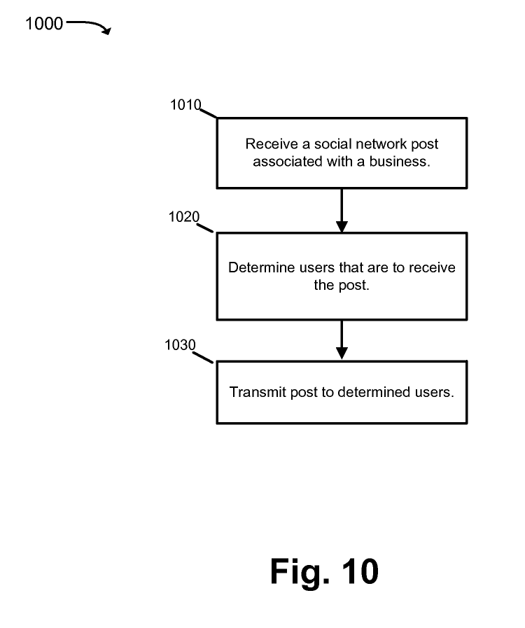

FIG. 10 is a flow chart illustrating an example process 1000 relating to the providing of social network posts, associated with businesses 210, to users 220. Process 1000 may be performed by, for example, server 240.

Process 1000 may include receiving a social network post associated with a business (block 1010). As previously mentioned, a business 210 may provide, to server 240, information relating to social network posts that the business chooses to share with users 220. For example, data structure 400 may include an identification of social network feeds (field 425) and/or other information that server 240 may use to obtain posts that are made by the business. Based on this information, server 240 may obtain the posts, such as from servers associated with the social networks.

Process 100 may further include determining users that are to receive the social network post (block 1020). In various implementations, the users that are receive the social network post may include users that have previously indicated an interest in receiving information about the business, users that are within a certain distance of the business, or based on other factors.

Process 1000 may further include transmitting the social network post to the determined users (block 1030). In one implementation, server 240 may transmit a copy of the social network post to each determined user. In a manner similar to the presenting of the broadcast messages (e.g., as described with respect to block 830), the post may be presented to the destination users as a pop-up message, as an email message, or as a message in another format.

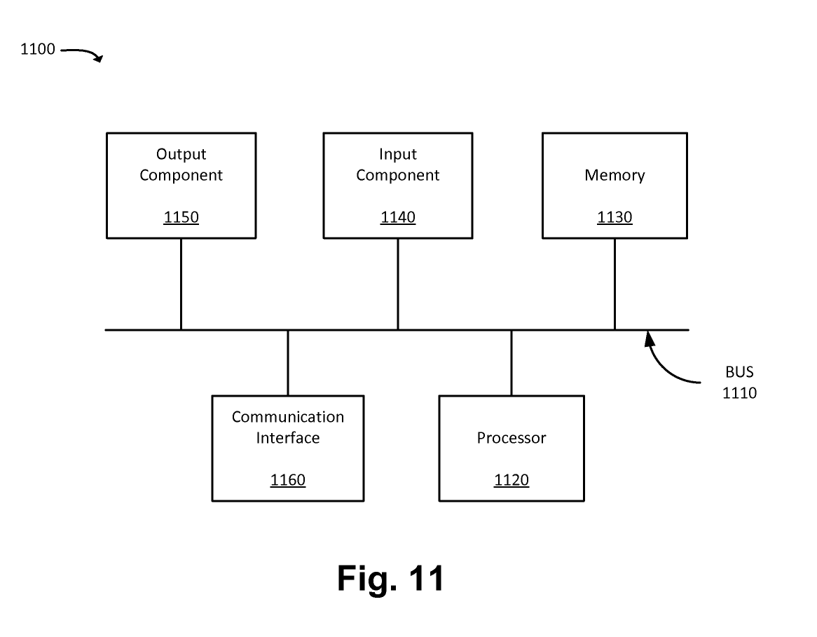

FIG. 11 is a diagram of example components of device 1100. One or more of the devices described above (e.g., as described with respect to FIGS. 1-3) may include one or more devices 1100. Device 1100 may include bus 1110, processor 1120, memory 1130, input component 1140, output component 1150, and communication interface 1160. In another implementation, device 1100 may include additional, fewer, different, or differently arranged components.

Bus 1110 may include one or more communication paths that permit communication among the components of device 1100. Processor 1120 may include a processor, microprocessor, or processing logic that may interpret and execute instructions. Memory 1130 may include any type of dynamic storage device that may store information and instructions for execution by processor 1120, and/or any type of non-volatile storage device that may store information for use by processor 1120.

Input component 1140 may include a mechanism that permits an operator to input information to device 1100, such as a keyboard, a keypad, a button, a switch, etc. Output component 1150 may include a mechanism that outputs information to the operator, such as a display, a speaker, one or more light emitting diodes (“LEDs”), etc.

Communication interface 1160 may include any transceiver-like mechanism that enables device 1100 to communicate with other devices and/or systems. For example, communication interface 1160 may include an Ethernet interface, an optical interface, a coaxial interface, a radio interface, or the like. For example, communication interface 1160 may include a wireless communication device, such as an infrared (“IR”) receiver, a Bluetooth radio, a Wi-Fi radio, etc. In some embodiments, device 1100 may include more than one communication interface 1160. For instance, device 1100 may include multiple radio interfaces, an optical interface, and an Ethernet interface.

Device 1100 may perform certain operations relating to one or more processes described above. Device 1100 may perform these operations in response to processor 1120 executing software instructions stored in a computer-readable medium, such as memory 1130. A computer-readable medium may be defined as a non-transitory memory device. A memory device may include space within a single physical memory device or spread across multiple physical memory devices. The software instructions may be read into memory 1130 from another computer-readable medium or from another device. The software instructions stored in memory 1130 may cause processor 1120 to perform processes described herein. Alternatively, hardwired circuitry may be used in place of or in combination with software instructions to implement processes described herein. Thus, implementations described herein are not limited to any specific combination of hardware circuitry and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while series of blocks have been described with regard to FIGS. 6, 8, and 10, the order of the blocks may be modified in other implementations. Further, non-dependent blocks may be performed in parallel.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A server device comprising:
a non-transitory memory device storing a set of computer-executable instructions; and
a processor configured to execute the set of computer-executable instructions, wherein executing the set of computer-executable instructions causes the processor to:
receive, from a user, a search query for businesses that are local to the user;
determine, based on access of a data structure, a location of the user;
generate, based on the location of the user and the search query, search results that satisfy the search query, the search results including information relating to at least one business that is a local businesses relative to the location of the user, the information including
identification of a name of the at least one business,
identification of an address of the at least one business, and
information relating to one or more telecommunication services that are used by the at least one business, the information relating to one or more telecommunication services being obtained from a telecommunication provider associated with providing of the one or more telecommunication services; and
transmit the search results to a computing device associated with the user.

2. The server device of claim 1, wherein the information relating to the one or more telecommunication services includes:
information regarding television channels currently being shown by the at least one business; or
information regarding pay-per-view shows that have been ordered by the at least one business.

3. The server device of claim 1, wherein the information relating to the one or more telecommunication services includes:
information regarding Wi-Fi hotspots associated with the at least one business.

4. The server device of claim 1, wherein executing the set of computer-executable instructions further causes the processor to:
determine a neighborhood associated with a residence of the user; and
generate the search results to include the at least one business as a local business that is in the determined neighborhood.

5. The server device of claim 1, wherein the user is a customer of a telecommunication provider, and wherein executing the set of computer-executable instructions further causes the processor to:
receive, from the user, a request to broadcast a message to other users that are customers of the telecommunication provider;
determine, based on the request to broadcast the message, a set of destination users; and
transmit the message to set-top boxes associated with the set of destination users.

6. The server device of claim 6, wherein, when determining the set of destination users, the set of computer-executable instructions further causes the processor to:
determine the set of destination users based on a neighborhood associated with the user and neighborhoods associated with the other users that are customers of the telecommunication provider.

7. The server device of claim 1, wherein the computing device to which the search results are transmitted includes a set-top box.

8. The server device of claim 1, wherein the computing device associated with the user includes a set-top box, and wherein executing the set of computer-executable instructions further causes the processor to:
receive social network posts associated with the at least one business; and
transmit the social network posts to the computing device associated with the user.

9. The server device of claim 1, wherein the location of the user includes a location of a a residence associated with the user.

10. A method comprising:
receiving, by a server device, a search query for businesses that are local to the user;
determining, by the server device and based on access of a data structure, a location of a user;
generating, by the server, and based on the location of the user and the search query, search results that satisfy the search query, the search results including information relating to at least one business that is a local businesses relative to the location of the user, the information including
identification of a name of the at least one business,
identification of an address of the at least one business, and
information relating to one or more telecommunication services that are used by the at least one business, the information relating to one or more telecommunication services being obtained from a telecommunication provider associated with providing of the one or more telecommunication services; and
transmitting, by the server, the search results to a computing device associated with the user.

11. The method of claim 10, wherein the information relating to the one or more telecommunication services includes:
information regarding television channels currently being shown by the at least one business; or
information regarding pay-per-view shows that have been ordered by the at least one business.

12. The method of claim 10, wherein the information relating to the one or more telecommunication services includes:
information regarding Wi-Fi hotspots associated with the at least one business.

13. The method of claim 10, wherein the method further includes:
determining a neighborhood associated with a residence of the user; and
generating the search results to include the at least one business as a local business that is in the determined neighborhood.

14. The method of claim 10, wherein the user is a customer of a telecommunication provider, and wherein the method further includes:
receiving, from the user, a request to broadcast a message to other users that are customers of the telecommunication provider;
determining, based on the request to broadcast the message, a set of destination users; and
transmitting the message to set-top boxes associated with the set of destination users.

15. The method of claim 14, wherein determining the set of destination users includes:
determining the set of destination users based on a neighborhood associated with the user and neighborhoods associated with the other users that are customers of the telecommunication provider.

16. The method of claim 10, wherein the computing device to which the search results are transmitted includes a set-top box.

17. The method of claim 10, wherein the computing device associated with the user includes a set-top box, and wherein the method further includes:
receiving social network posts associated with the at least one business; and
transmitting the social network posts to the computing device associated with the user.

18. A device comprising:
a non-transitory memory device storing a set of computer-executable instructions; and
a processor configured to execute the set of computer-executable instructions, wherein executing the set of computer-executable instructions causes the processor to:
receive indications of television channels being viewed at businesses;
receive, from a user, a request for information relating to businesses that are local to the user;
determine, based on access of a data structure, a location of a residence of the user;
determined, based on the location of the residence of the user and based on the request, one or more businesses that are local to the user;
generate a response to the request, the response including, for each of the one or more businesses that are determined to be local to the user:
identification of a name of the business of the one or more businesses,
identification of an address of the business of the one or more businesses, and
information regarding the television channels currently being viewed at the business of the one or more businesses; and
transmit the response to a computing device associated with the user.

19. The device of claim 18, wherein the response further includes:
information regarding Wi-Fi hotspots associated with the business.

20. The device of claim 18, wherein the user is a customer of a telecommunication provider, and wherein executing the set of computer-executable instructions further causes the processor to:
receive, from the user, a request to broadcast a message to other users that are customers of the telecommunication provider;
determine, based on the request to broadcast the message, a set of destination users; and
transmit the message to set-top boxes associated with the set of destination users.
